(19) United States
(12) Patent Application Publication
(10) Pub. No.: US 2015/0367541 A1
(43) Pub. Date: Dec. 24, 2015

(54) VEHICLE INTERIOR TRIM COMPONENTS AND ASSOCIATED METHODS

(71) Applicant: GM GLOBAL TECHNOLOGY OPERATIONS LLC, Detroit, MI (US)

(72) Inventor: LORIN A. MAZUR, SHELBY, MI (US)

(21) Appl. No.: 14/309,504

(22) Filed: Jun. 19, 2014

(51) Int. Cl. B29C 41/08; C09D 175/04; B29C 41/22; B29C 65/02; B32B 23/04; B29C 41/00

(52) U.S. Cl. CPC B29C 41/085; B32B 23/04; B29C 41/003; B29C 41/22; B29C 65/02; C09D 175/04; B32B 2255/28; B32B 2266/02; B32B 2605/003; B32B 2307/402; B29L 2009/005

(57) ABSTRACT

Interior soft trim components for a vehicle and methods for manufacturing the same are presented. Embodiments of the disclosed soft interior trim components may be manufactured using a spray application process. In some embodiments, the disclosed soft interior trim components may comprise a urethane skin layer and a urethane foam backer layer formed using a spray application process. The skin layer and foam backer layer may be bonded to a substrate material providing structure for the interior trim components. In certain embodiments, the skin layer and foam backer layer may be bonded to the substrate material prior to the foam backer layer curing, thereby allowing for bonding of the skin layer and foam backer layer to the substrate material without the use and/or with reduced use of adhesives.

### TECHNICAL FIELD

This disclosure relates to trim components of a vehicle. More specifically, but not exclusively, the systems and methods disclosed herein relate to interior trim components of a vehicle and methods for manufacturing the same.

### BACKGROUND

Passenger vehicles include a variety of interior trim components. Interior trim components may be attached to or formed integrally with various surfaces of a vehicle interior including, for example, a door panel, an instrument panel, a dashboard, and/or the like. Certain interior trim components may be soft and/or otherwise have some degree of compressibility. Conventional soft interior trim components may be constructed using a separate sheet foam layer and/or adhesives to bind the separate foam layer to a substrate material and/or an aesthetically pleasing interior surface (e.g., using a foam-in-place or a press laminate process). Constructing soft interior trim components using a separate foam layer and/or binding adhesives, however, introduces increased scrap material during the manufacturing process and/or costs associated with the same.

### SUMMARY

Systems and methods disclosed herein may, among other things, provide for soft interior trim components and/or methods of manufacturing the same. Embodiments of the disclosed soft interior trim components may be manufactured using a spray application process. In some embodiments, the disclosed soft interior trim components may comprise a skin layer and a foam backer layer formed using a spray application process. In certain embodiments, the skin layer and/or foam backer layer may comprise urethane materials, although it will be appreciated that other types of materials may be utilized in connection with the disclosed embodiments including, without limitation, polyurethane, thermoplastic materials, ethylene vinyl acetate (“EVA”), semi-rigid expanded foam materials, polyethylene, bio-based materials, polyvinyl chloride (“PVC”) and/or the like.

Embodiments of the disclosed interior trim components may be formed by spraying the skin layer in an appropriate mold and/or form tool and subsequently spraying the foam backer layer over the skin layer. In some embodiments, the mold and/or form tool may provide a certain amount of shape to the sprayed skin layer and/or the foam backing layer. The foam backer layer may be bonded to a substrate material providing shape and/or structure to the interior trim component (e.g., using a mechanical compression molding and/or a vacuum compression molding process). The substrate material may comprise any suitable material or combination of materials for providing shape and/or structure to the interior trim component including, without limitation, natural fiber materials, plastics, and/or the like. The substrate material may be formed using a variety of suitable processes including, for example, injection molding, compression molding, and/or the like. In certain embodiments the substrate material may be configured to be secured to one or more interior panel components of a vehicle interior using one or more discrete and/or integral fasteners, thereby securing the interior trim component to the vehicle.

In certain embodiments, the disclosed interior trim components may be formed without use of a separate sheet foam layer and/or certain binding adhesives. For example, by applying the foam layer directly to the skin layer through a spray application process, the use of a separately formed sheet foam layer and/or binding adhesives may be reduced or eliminated with the disclosed embodiments. In further embodiments, the foam backer layer may be bonded to the substrate material following the spray application before the foam backer layer has cured (e.g., while the foam backer layer remains tacky), thereby reducing or eliminating the use of bonding adhesives between the foam backer layer and the substrate material. Embodiments of the disclosed interior trim components and associated methods may, among other things, reduce scrap material (e.g., by reducing or eliminating excess foam backer), reduce manufacturing costs and/or time, and/or reduce density and/or mass of interior trim components.

In some embodiments, a method for forming an interior trim component may include applying a urethane color coat of a skin layer of an interior trim component into a mold and/or form tool using a spraying process. In certain embodiments, the mold and/or form tool may define a shape of the interior trim component and/or may create a texture on the interior surface of the color coat. A urethane structural coat of the skin layer may be applied to an exterior surface of the applied color coat using the spraying process. A urethane foam backer layer may then be applied on an exterior surface of the structural coat using the spraying process. An exterior surface of the foam backer layer may be bonded to a substrate material configured to provide structure to the interior trim component. In some embodiments, the foam backer layer may be bonded to the substrate material prior to the exterior surface of the foam backer layer curing. In this manner, the foam backer layer may be bonded to the substrate material without the use of separate adhesives.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates cross sectional view of an interior trim component consistent with embodiments disclosed herein.

FIG. 2 illustrates a flow chart of an exemplary method for manufacturing an interior trim component consistent with embodiments disclosed herein.

### DETAILED DESCRIPTION

A detailed description of systems and methods consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The embodiments of the disclosure will be best understood by reference to the drawings, wherein like parts may be designated by like numerals. The components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified.

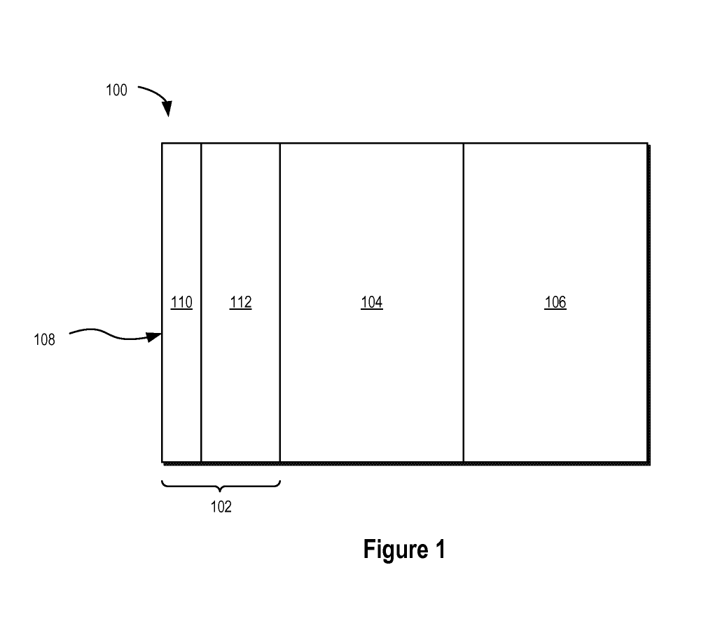

FIG. 1 illustrates cross sectional view 100 of an interior trim component consistent with embodiments disclosed herein. In certain embodiments, the interior trim component may be included in an interior of a vehicle. The vehicle may be a motor vehicle, a marine vehicle, an aircraft, and/or any other type of vehicle. The interior trim component may comprise any type of interior vehicle trim component including, without limitation, a door trim component, a seat trim component, an instrument panel trim component, a dashboard trim component, a sidewall trim component, a headliner trim component, an armrest trim component, a cabin environment control console trim component, and/or the like. In certain embodiments, the interior trim component may comprise a soft interior trim component. For example, in some embodiments, the interior trim component may be soft to the touch and/or otherwise have some degree of compressibility. Although embodiments disclosed herein are discussed in connection with interior trim components of a vehicle, it will be appreciated that embodiments of the disclosed trim components and/or associated methods may also be used in connection with a variety of other applications utilizing soft trim components including, for example, indoor furniture, outdoor furniture, and/or the like.

As illustrated, the interior trim component may comprise one or more layers 102, 104 bonded to a substrate material 106. In some embodiments, the one or more layers 102, 104 may comprise one or more urethane materials applied using a spray application process.

An interior surface 108 of the interior trim component may comprise a skin layer 102. In certain embodiments, the skin layer 102 may comprise one or more coats 110, 112 of a urethane material applied using a spray application process. In certain embodiments, the one or more coats 110, 112 of urethane material may comprise materials having different physical properties (e.g., hardnesses, thicknesses, color, composition, etc.). In other embodiments, the one or more coats 110, 112 may comprise the same urethane material.

As discussed above, the various layers 102, 104 and/or constituent coats 110, 112 may be formed using a spray application process. In some embodiments, as part of the spray application process, the various layers 102, 104 and/or constituent coats 110, 112 of the interior trim component may be sprayed into a form and/or molding tool. In certain embodiments, the form and/or molding tool may have a shape that is the same and/or similar to the final interior trim component. In this manner, the various layers 102, 104 and/or constituent coats 110, 112 formed using the spray application process may have a shape that is the same and/or similar to the final interior trim component. In certain embodiments, this may facilitate easier and more robust bonding of the layers 102, 104 to a substrate material 106 (e.g., due to less latent energy and/or structural rigidity to overcome in bonding layers 102, 104 to the substrate material 106).

The skin layer 102 may comprise a color coat 110 and a structural coat 112. The color coat 110 may provide an aesthetically-pleasing interior surface 108 that may be viewed from the interior of a vehicle that includes the interior trim component. In some embodiments, the color coat 110 may comprise a urethane material having a certain color and/or pigmentation and/or a combination of a plurality of colors and/or pigmentations. In certain embodiments, the color coat 110 may further comprise a material having properties allowing for increased wear. In some embodiments, the color coat 110 may have a thickness of about 0.1 mm to 0.3 mm. For example, in certain embodiments, the color coat may have nominal thickness of 0.2 mm.

In some embodiments, the interior surface 108 of the color coat 110 may have a certain texture and/or pattern. In certain embodiments, the texture and/or pattern may simulate a pattern of another material. For example, the texture and/or pattern may provide the interior surface 108 of the color coat 110 with the appearance of leather, a textile fabric, and/or the like. In certain embodiments, the texture and/or pattern may be included in a form and/or molding tool used to form elements of the interior trim component, and may be created on the color coat 110 when the color coat 110 is sprayed into the form and/or molding tool. In further embodiments, the texture and/or pattern may be created using a mechanical and/or thermal process such as a thermal compression process configured to imprint and/or otherwise create the texture and/or pattern on the color coat 110 with applied heat.

After application of the color coat 110, the structural coat 112 may be applied. As illustrated, the structural coat 112 may be applied directly to an exterior surface of the color coat 110 (i.e., without bonding adhesives or the like). The structural coat 112 may comprise a urethane material that may be the same or a different material than the color coat 110. In certain embodiments, the structural coat 112 may have a thickness of about 0.4 mm to 0.6 mm. For example, in certain embodiments, the structural coat 112 may have nominal thickness of 0.5 mm.

Following application of the structural coat 112, a foam layer 104 may be applied. As illustrated, the foam layer 104 may be applied directly to an exterior surface of the structural coat 112. Like the constituent coats 110, 112 of the skin layer 102, the foam layer 104 may comprise a urethane material applied using a spray application process. In certain embodiments, the foam layer 104 may provide a certain degree of compressibility to a surface (e.g., interior surface 108) of the interior trim component.

In some embodiments, the foam layer 104 may comprise the same and/or similar urethane material as the skin layer 102 and/or its constituent coats 110, 112. In other embodiments, the foam layer 104 may comprise a different urethane material than the skin layer 102 and/or its constituent coats 110, 112. In certain embodiments, the foam layer 104 may have a thickness of about 1 mm to 6 mm. For example, in some embodiments, the foam layer 104 may have a nominal thickness of about 2 mm to 3 mm.

The foam layer 104 may be bonded to a substrate material 106 providing shape and/or structure to the interior trim component. The substrate material 106 may be formed using a variety of suitable processes including, without limitation, injection molding, compression molding, vacuum compression molding, and/or the like. The substrate material 106 may comprise any suitable material or combination of materials for providing shape and/or structure to the interior trim component. For example, in some embodiments, the substrate material 106 may comprise a natural fiber material, a plastic material, and/or the like. In some embodiments, the substrate material 106 may be configured to be secured to one or more interior panel components of a vehicle interior using one or more discrete and/or integral fasteners (not shown), thereby securing the interior trim component to the vehicle.

In certain embodiments, the foam layer 104 may be bonded to the substrate material 106 without the use of binding adhesives. For example, in certain embodiments, the foam layer 104 may be bonded to the substrate material 106 following a spray application of the foam layer 104. In some embodiments, the foam layer 104 may be bonded to the substrate material 106 before the foam layer 104 material has cured and/or has otherwise dried (e.g., while the foam backer layer remains tacky), thereby allowing the foam layer 104 to adhere the substrate material 106 with the uncured material of the foam layer 104 acting as a binder therebetween. In this manner, the embodiments of the disclosed processes may reduce or eliminate the use of separate bonding adhesives between the foam layer 104 and the substrate material 106.

In some embodiments, the foam layer 104 may be bonded to the substrate material 106 using a mechanical compression process. In certain embodiments, heat may be introduced to the foam layer 104 and/or the substrate material 106 prior to and/or during a mechanical bonding process. In other embodiments, the skin layer 102 and bonded foam layer 104 may be bonded to the substrate material 106 before removal from the form and/or molding tool used to manufacture the skin layer 102 and bonded foam layer 104. In other embodiments, the skin layer 102 and bonded foam layer 104 may be bonded to the substrate material 106 after removal from the form and/or molding tool used to manufacture the skin layer 102 and bonded foam layer 104.

Embodiments of the disclosed interior trim components and the methods for manufacturing the same may, among other things, reduce and/or eliminate the use of separate binding adhesives, reduce the amount of scrap material produced during manufacturing (e.g., scrap sheet foam), increase manufacturing speed, decrease manufacturing costs, reduce manufacturing process steps, reduce internal component stress and/or possibility for component delamination, reduce the overall mass of interior trim components, and/or allow for use of multiple colors and/or patterns within a single process tool when compared to conventional methods for manufacturing soft interior trim components.

In certain embodiments, the substrate material 106 may be formed in parallel and/or substantially simultaneously with forming the skin layer 102 and/or bonded foam layer 104. For example, in some embodiments, the substrate material 106 and/or associated fasteners may be formed and/or otherwise assembled in a parallel manufacturing process and/or cycle with the forming of the skin layer 102 and/or the bonded foam layer 104. In certain embodiments, this may reduce total manufacturing time for each interior trim component, thereby allowing for increased production of interior trim components in a given time period. In further embodiments, the skin layer 102 and/or its constituent coats 110, 112 may be formed thinner than in conventional trim component skin layers, thereby decreasing curing time for the layer 102 and/or coats 110, 112 and/or reducing total manufacturing time for each interior component when compared to conventional components.

It will be appreciated that a number of variations can be made to the embodiments of the disclosed interior trim components presented in connection with FIG. 1 within the scope of the inventive body of work. For example, although embodiments are discussed above in connection with the use of urethane materials for forming the skin layer 102 and/or the foam layer 104, it will be appreciated that other types of materials may be utilized in connection with the disclosed embodiments including, without limitation, polyurethane, thermoplastic materials, EVA, semi-rigid expanded foam materials, polyethylene, bio-based materials, PVC and/or the like. Thus it will be appreciated that FIG. 1 is provided for purposes of illustration and explanation and not limitation.

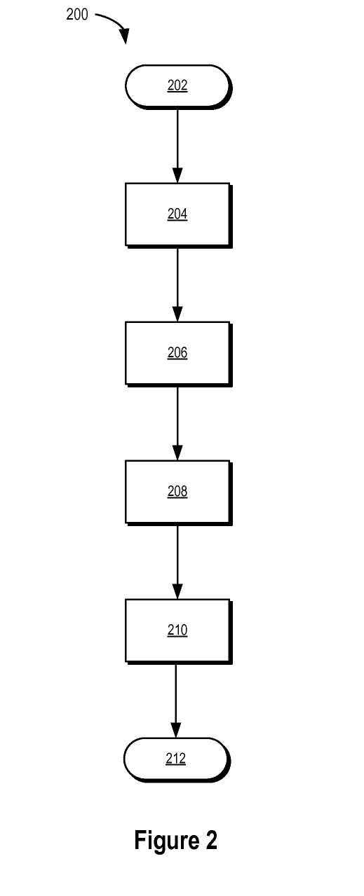

FIG. 2 illustrates a flow chart of an exemplary method 200 for manufacturing an interior trim component consistent with embodiments disclosed herein. At 202, the method 200 may initiate. At 204, a urethane color coat of skin layer of the interior trim component may be applied into a mold and/or form tool using a spraying process. In certain embodiments, the mold and/or form tool may define a shape of the interior trim component and/or may create a texture on the interior surface of the color coat. At 206, a urethane structural coat of the skin layer may be applied to an exterior surface of the applied color coat using the spraying process. In certain embodiments, the color coat and/or the structural coat may be applied in a single spraying process and/or comprise the same urethane material. In other embodiments, the color coat and/or the structural coat may be applied in separate spraying processes and/or comprise different urethane materials.

At 208, a urethane foam backer layer may be applied on the exterior surface of the structural coat using the spraying process. An exterior surface of the foam backer layer may be bonded to a substrate material configured to provide structure to the interior trim component at 210. In certain embodiments, the foam backer layer may be bonded to the substrate material after removing the skin layer and the foam backer layer from the mold and/or form tool. In further embodiments, the foam backer layer may be bonded to the substrate material prior to the exterior surface of the foam backer layer curing. In this manner, the foam backer layer may be bonded to the substrate material without the use of separate adhesives. In some embodiments, heat may be applied prior to and/or during bonding of the foam backer layer to the substrate material. The method 200 may proceed to terminate at 212.

Although the foregoing has been described in some detail for purposes of clarity, it will be apparent that certain changes and modifications may be made without departing from the principles thereof. It is noted that there are many alternative ways of implementing both the processes and systems described herein. Accordingly, the present embodiments are to be considered illustrative and not restrictive, and the invention is not to be limited to the details given herein, but may be modified within the scope and equivalents of the appended claims.

The foregoing specification has been described with reference to various embodiments. However, one of ordinary skill in the art will appreciate that various modifications and changes can be made without departing from the scope of the present disclosure. For example, various operational steps, as well as components for carrying out operational steps, may be implemented in alternate ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

As used herein, the terms “comprises” and “includes,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

1. A method of manufacturing an interior trim component for a vehicle, the method comprising:
applying a color coat of a skin layer of the interior trim component into a form tool using a spraying process, the form tool providing a shape of the interior trim component;
applying a structural coat of the skin later on an exterior surface of the applied color coat using the spraying process; and
applying a foam backer layer on an exterior surface of the structural coat using the spraying process.

2. The method of claim 1, wherein the color coat comprises a urethane material.

3. The method of claim 1, wherein an interior surface of the applied color coat comprises a texturized surface.

4. The method of claim 3, wherein the texturized surface is formed when the color coat is applied into the form tool.

5. The method of claim 1, wherein the structural coat comprises a urethane material.

6. The method of claim 1, wherein the foam backer layer comprises a urethane material.

7. The method of claim 1, wherein the method further comprises:
bonding an exterior surface of the foam backer layer to a substrate material configured to provide structure to the interior trim component.

8. The method of claim 7, wherein the method further comprises:
removing the applied color coat, structural coat, and foam backer layer from the form tool prior to bonding the exterior surface of the foam backer layer to the substrate material.

9. The method of claim 7, wherein bonding the exterior surface of the foam backer layer to the substrate material comprises mechanically compressing the color coat, structural coat, and foam backer layer against an interior surface of the substrate material before the exterior surface of the foam backer layer has cured.

10. The method of claim 9, wherein the method further comprises:
applying heat to the substrate material prior to bonding of the exterior surface of the foam backer layer to the substrate material.

11. The method of claim 9, wherein the method further comprises:
applying heat to the substrate material during bonding of the exterior surface of the foam backer layer to the substrate material.

12. The method of claim 7, wherein the substrate material comprises a natural fiber material.

13. The method of claim 7, wherein the substrate material comprises an injection molded plastic material.

14. The method of claim 1, wherein a thickness of the color coat ranges from about 0.1 millimeters to 0.3 millimeters.

15. The method of claim 1, wherein a thickness of the structural coat ranges from about 0.4 millimeters to 0.6 millimeters.

16. The method of claim 1, wherein a thickness of the foam backer layer ranges from about 1 millimeters to 6 millimeters.

17. An interior trim component for a vehicle comprising:
a skin layer comprising:
a urethane color coat formed using a spraying process, the urethane color coat including an interior texturized surface;
a urethane structural coat formed using the spraying process, the urethane structural coat being formed on an exterior surface of the urethane color coat and including; and
a urethane foam backer layer formed using the spraying process, the urethane foam backer layer being formed on an exterior surface of the urethane structural coat.

18. The interior trim component of claim 17 further comprising:
a substrate material configured to provide structure to the interior trim component bonded to an exterior surface of the urethane foam backer layer.

19. The interior trim component of claim 18, wherein the substrate material is bonded to the exterior surface of the urethane foam backer layer without the use of adhesives.

20. The interior trim component of claim 19, wherein the substrate material is bonded to the exterior surface of the urethane foam backer layer prior to curing of the urethane foam backer layer.
